(19) United States
(12) Patent Application Publication
(10) Pub. No.: US 2014/0263019 A1
(43) Pub. Date: Sep. 18, 2014

(54) Cartridge Structure for a Water Filter

(71) Applicant: Te-Sheng Wu, Taoyuan County (TW)

(72) Inventor: Te-Sheng Wu, Taoyuan County (TW)

(21) Appl. No.: 13/840,882

(22) Filed: Mar. 15, 2013

(51) Int. Cl. C02F 1/00; B01D 27/02

(52) U.S. Cl. CPC C02F 1/003; B01D 27/02
USPC 210/232

(57) ABSTRACT

A cartridge structure for a water filter contains a body, an upper cover connected with the body, and a lower cover coupled with the body. The body includes plural filtering layers defined therein, the upper cover includes an inlet defined on a top end thereof and a first groove formed around an inner side thereof, and the lower cover includes an outlet defined on a bottom end thereof and a second groove formed around an inner side thereof, such that plurality of filtering materials are fixed in the first groove and the second groove. Thereby, water flows into the inlet and then is filtered by the filtering materials and the filtering layers so as to enhance filtering effect. Also, after a period of using time, the upper cover and the lower cover are removed from the body so as to take the filtering layers, thus recycling the filtering layers.

### FIELD OF THE INVENTION

The present invention relates to a cartridge structure for a water filter which enhances filtering effect and after a period of using time, the filtering layers are taken out so as to be recycled.

### BACKGROUND OF THE INVENTION

A conventional cartridge structure for a water filter contains a closed body, and the closed body includes an inlet, an outlet, and plural filtering materials, such that water flows through the plural filtering materials so as to filter impurities and bacteria. However, the plural filtering materials decrease filtering effect after a period of using time, so user has to replace new filtering materials and to discard the filtering materials, thus causing material waste and environment pollution.

The present invention has arisen to mitigate and/or obviate the afore-described disadvantages.

### SUMMARY OF THE INVENTION

The primary object of the present invention is to provide a cartridge structure for a water filter in which the body includes the plurality of filtering layers defined therein, and the upper cover and the lower cover include the plurality of filtering materials fixed therein, thus enhancing filtering effect.

Another object of the present invention is to provide a cartridge structure for a water filter which after a period of using time, the plurality of filtering layers are taken out, thus obtaining recycle and environmental protection.

To obtain the above objective, a cartridge structure for a water filter provided by the present invention contains: a body, an upper cover connected with the body, and a lower cover coupled with the body.

The body includes a plurality of filtering layers defined therein, the upper cover includes an inlet defined on a top end thereof and a first groove formed around an inner side thereof, and the lower cover includes an outlet defined on a bottom end thereof and a second groove formed around an inner side thereof, such that plurality of filtering materials are fixed in the first groove and the second groove.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view showing the assembly of a cartridge structure for a water filter according to a preferred embodiment of the present invention.

FIG. 2 is a perspective view showing the exploded components of the cartridge structure for the water filter according to the preferred embodiment of the present invention.

FIG. 3 is a cross sectional view showing the assembly of the cartridge structure for the water filter according to the preferred embodiment of the present invention.

FIG. 4 is a cross sectional view showing the operation of the cartridge structure for the water filter according to the preferred embodiment of the present invention.

### DETAILED DESCRIPTION OF THE PREFERRED EMBODIMENTS

FIG. 1 is a perspective view showing the assembly of a cartridge structure for a water filter according to a preferred embodiment of the present invention. FIG. 2 is a perspective view showing the exploded components of the cartridge structure for the water filter according to the preferred embodiment of the present invention. Referring to FIGS. 1 and 2, a cartridge structure for a water filter of the present invention comprises: a body 1, an upper cover 2 connected with the body 1, and a lower cover 3 coupled with the body 1. The body 1 includes a first threaded section 11 formed on an upper end thereof and a second threaded section 12 arranged on a lower end thereof. The body 1 also includes a plurality of filtering layers 13, 14, 15 defined therein. In this embodiment, each filtering layer 13, 14, or 15 is formed of sands or environmentally friendly materials with far infrared rays.

The upper cover 2 includes an inlet 21 defined on a top end thereof and a first groove 22 formed around an inner side thereof, and the lower cover 3 includes an outlet 31 defined on a bottom end thereof and a second groove 32 formed around an inner side thereof, such that plurality of filtering materials 4, 5, 6 are fixed in the first groove 22 and the second groove 32. In this embodiment, two flexible C-retainers 7 are retained in the first groove 22 and the second groove 23 so to fix the plurality of filtering materials 4, 5, 6 which are fixed in the first groove 22 and the second groove 32. Furthermore, the upper cover 2 includes first threads 23 defined around the inner side thereof adjacent to an opening of the upper cover 2, and the lower cover 3 includes second threads defined around the inner side thereof adjacent to an opening of the lower cover 3, such that the first threads 23 of the upper cover 2 screw with the first threaded section 11 of the body 1, and the second threads 33 of the lower cover 3 screw with the second threaded section 12 of the body 1.

In operation, water flows into the inlet 21 of the upper cover 2 and then is filtered by the plurality of filtering materials 4, 5, 6 and the plurality of filtering layers 13, 14, 15 so as to enhance filtering effect. After a period of using time, the upper cover 2 and the lower cover 3 are removed from the body 1 so as to take the plurality of filtering layers 13, 14, 15 out, thus recycling and replacing the plurality of filtering layers 13, 14, 15.

FIG. 3 is a cross sectional view showing the assembly of the cartridge structure for the water filter according to the preferred embodiment of the present invention. The first groove 22 of the upper cover 2 has a stepped portion defined on an inner rim thereof, and the stepped portion of the first groove 22 has a first slot 221 formed thereon, the second groove 32 of the upper cover 3 has a stepped portion defined on an inner rim thereof, and the stepped portion of the second groove 32 has a second slot 321 formed thereon, such that the plurality of filtering materials 4, 5, 6 are fixed on two stepped portions of the first groove 22 and the second stepped groove 32. Thereafter, the two flexible C-retainers 7 are retained in the first slot 221 and the second slot 321 (i.e., the two flexible C-retainers 7 are clamped by a tool and placed into the first slot 221 and the second slot 321, thus retaining the two flexible C-retainers 7 in the first slot 221 and the second slot 321), such that the plurality of filtering materials 4, 5, 6 are fixed by the two flexible C-retainers 7 securely.

FIG. 4 is a cross sectional view showing the operation of the cartridge structure for the water filter according to the preferred embodiment of the present invention. In operation, water flows into the inlet 21 of the upper cover 2 and is filtered by the plurality of filtering materials 4, 5, 6 so as to filter impurities in the water and is filtered by the plurality of filtering layers 13, 14, 15 so as to filter bacteria in the water. Thereafter, the water flows into the plurality of filtering materials 4, 5, 6 of the lower cover 3 so as to further filter impurities in the plurality of filtering layers 13, 14, 15. It is preferable that after a period of using time, the upper cover 2 and the lower cover 3 are removed from the body 1 so as to take the plurality of filtering layers 13, 14, 15 out, thus recycling and replacing the plurality of filtering layers 13, 14, 15.

Thereby, the body includes the plurality of filtering layers defined therein, and the upper cover and the lower cover include the plurality of filtering materials fixed therein, thus enhancing filtering effect. Also, after a period of using time, the plurality of filtering layers are taken out, thus obtaining recycle and environmental protection.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A cartridge structure for a water filter comprising:
a body, an upper cover connected with the body, and a lower cover coupled with the body, wherein the body includes a plurality of filtering layers defined therein, the upper cover includes an inlet defined on a top end thereof and a first groove formed around an inner side thereof, and the lower cover includes an outlet defined on a bottom end thereof and a second groove formed around an inner side thereof, such that plurality of filtering materials are fixed in the first groove and the second groove;
thereby water flows into the inlet of the upper cover and then is filtered by the plurality of filtering materials and the plurality of filtering layers so as to enhance filtering effect, and after a period of using time, the upper cover and the lower cover are removed from the body so as to take the plurality of filtering layers, thus recycling the plurality of filtering layers.

2. The cartridge structure for the water filter as claimed in claim 1, wherein the first groove of the upper cover has a stepped portion defined on an inner rim thereof, and the stepped portion of the first groove has a first slot formed thereon, the second groove of the upper cover has a stepped portion defined on an inner rim thereof, and the stepped portion of the second groove has a second slot formed thereon, such that the plurality of filtering materials are fixed on two stepped portions of the first groove and the second stepped groove, and two flexible C-retainers are retained in the first groove and the second groove so to fix the plurality of filtering materials which are fixed in the first groove and the second groove.

3. The cartridge structure for the water filter as claimed in claim 1, wherein each filtering layer is formed of sands.

4. The cartridge structure for the water filter as claimed in claim 1, wherein each filtering layer is formed of environmentally friendly materials with far infrared rays.

5. The cartridge structure for the water filter as claimed in claim 1, wherein the body includes a first threaded section formed on an upper end thereof and a second threaded section arranged on a lower end thereof, and the upper cover includes first threads defined around the inner side thereof adjacent to an opening of the upper cover, the lower cover includes second threads defined around the inner side thereof adjacent to an opening of the lower cover, such that the first threads of the upper cover screw with the first threaded section of the body, and the second threads of the lower cover screw with the second threaded section of the body.
